(19) United States
(12) Patent Application Publication
(10) Pub. No.: US 2013/0106649 A1
(43) Pub. Date: May 2, 2013

(54) METHODS AND APPARATUS FOR WIDE AREA SYNTHETIC APERTURE RADAR DETECTION

(71) Applicants: Kenneth W. Brown, Yucaipa, CA (US); David R. Sar, Corona, CA (US); Michael J. Sotelo, Chino, CA (US); Elbert H. Ko, Downey, CA (US); David D. Crouch, Corona, CA (US)

(72) Inventors: Kenneth W. Brown, Yucaipa, CA (US); David R. Sar, Corona, CA (US); Michael J. Sotelo, Chino, CA (US); Elbert H. Ko, Downey, CA (US); David D. Crouch, Corona, CA (US)

(21) Appl. No.: 13/649,442

(22) Filed: Oct. 11, 2012

Related U.S. Application Data
(60) Provisional application No. 61/553,560, filed on Oct. 31, 2011.

(51) Int. Cl. G01S 13/90

(52) U.S. Cl. 342/25 A

(57) ABSTRACT

Methods and apparatus for providing a first radar system having a transmitter and a receiver and a reflector to provide a synthetic aperture radar relationship. The signal return is processed to generate an image of targets in the area.

### BACKGROUND

As known in the art, a variety of radar technologies can be used to detect objects of interest. One such system is known as synthetic aperture radar (SAR). Synthetic-aperture radar (SAR) uses relative motion between an antenna and a target region to provide distinctive long-term coherent-signal variations that can be exploited to obtain finer spatial resolution as compared to conventional beam-scanning means. Known SAR systems are typically implemented by mounting a single beam-forming antenna on a moving platform. A target scene is repeatedly illuminated with pulses of radio waves. The signal return received at the various antenna positions are coherently detected and processed to resolve elements in an image of the target region.

Current Synthetic Aperture Radar (SAR) systems suffer from several physical and electromagnetic constraints which can limit the utility of the technique. Typically, the radar operates from an aircraft As the aircraft flies along a predetermined course (preferably a straight line or a turn about a point) radar data is collected. This data is then processed to reveal the radar “image” Depending on the radar wavelength, target location, aircraft altitude and the flight profile, obtaining a radar image may require that the airplane fly several miles to collect the data. While there is often no substitute for this in the field or in a military theater, it can be expensive, cumbersome, and time consuming. There are few practical methods to take similar data in the confines of a testing laboratory within a reasonable period of time. Additionally, simulations cannot completely cover all of the aspects and complexities provided by actual SAR radar data.

### SUMMARY

Exemplary embodiments of the invention provide methods and apparatus for a wideband mmW Synthetic Aperture Radar (SAR) coupled to a reflector antenna system. Through the use of wide band wave forms, and inventive beam feed and reflector designs, the size, cost and time required to collect SAR imagery is reduced. While exemplary embodiments of the invention are shown and described in conjunction with illustrative configurations, frequencies and applications, it is understood that embodiments of the invention are applicable to applications in general In which is desirable to image objects in an area. Exemplary applications include collection of radar data on scale models of large objects to supplement simulation data, applications where detailed radar data for areas up to tens of meters on a side are desirable, area monitoring, traffic management, material handling, intrusion detection, which can include intrude location, and the like.

In one embodiment, the reflector antenna system converts a rotational radar beam movement Into a translational radar beam movement which repeatedly sweeps linearly from one side of the scene to the other, and which can be utilized to generate conventional SAR imagery. In this embodiment, the reflector that converts the beam to sweep linearly can be in the order of several feet long and several inches in height and have a paraboloid shape along its length, with the rotating radar transmitter located near the paraboloid focus. This allows for significantly faster scanning of a scene (e.g., by a factor of over 50) than would be possible if the radar was physically moved along the desired linear path.

In another embodiment, for utilizing SAR Imagery of individual objects on a compact scale, the radar resides In the center of a ring shaped reflector. This reflector directs the radar beam downward and back toward the radar axis of rotation. Objects placed beneath this radar/reflector configuration receive a 360 degree radar scan. In this case, SAR imagery is produced that is similar to that obtained when an airborne SAR. Images objects while turning on a point centered on the object. This allows SAR imagery data to he rapidly collected on Individual objects while keeping the volume of the equipment to a minimum.

In one embodiment, because the SAR radar only uses a single transceiver, its cost is substantially lower than current array-based Imaging systems. In other embodiments, additional transceivers and/or electronically steered phased array transceivers may be used when a desire to avoid mechanical radar rotation, an increase in resolution, or an increase in speed justifies the Increase in cost.

In one aspect of the invention, a system comprises: a first radar system having a transmitter to transmit signals to an area and a receiver to receive signal return from targets in the area, a reflector positioned in relation to the first radar system to reflect transmit signals from the transmitter to the area and signal return from the targets to the receiver, wherein at least one of the transmitter and the reflector moves in relation to the other to provide a synthetic aperture radar relationship, and a signal processor to process the signal return and generate an image of targets in the area.

The system can further include one or more of the following features: the radar system comprises a rotating radar for converting a rotational radar beam movement into translational radar beam movement, the reflector is stationary, the reflector is parabolic, the reflector is ring-shaped, a sub-reflector positioned in relation to the radar system and the reflector, the radar system transmit signals have a band width of up to 20 percent of a center frequency of the radar, the reflector is not diffraction limited, a further sensor to mitigate ambiguities in the image, and/or the further sensor includes at least one of a video system and a second radar system offset from the first radar system.

In another aspect of the invention, a method comprises: employing a first radar system having a transmitter to transmit signals to an area and a receiver to receive signal return from targets in the area, employing a reflector positioned in relation to the first radar system to reflect transmit signals from the transmitter to the area and signal return from the targets to the receiver, wherein at least one of the transmitter and the reflector moves in relation to the other to provide a synthetic aperture radar relationship, and processing the signal return with a computer processor and generating an image of targets in the area.

The method can further include one or more of the following features: rotating a radar for converting a rotational radar beam movement into translational radar beam movement, the reflector is ring-shaped, employing a sub-reflector positioned in relation to the radar system and the reflector, transmitting the transmit signals at a band width of up to 20 percent of the center frequency of the radar, the reflector is not diffraction limited, employing a further sensor to mitigate ambiguities in the image, and/or the further sensor includes at least one of a video system and a second radar system, offset from the first radar system.

In a further aspect of the invention, a system comprises; a first radar system having a transmitter to transmit signals to an area, and a receiver to receive signal return from targets in the area, a reflector means positioned in relation to the first radar system to reflect transmit signals from the transmitter to the area, and signal return .from the targets to the receiver, wherein at least one of the transmitter and the reflector moves in relation to the other to provide a synthetic aperture radar relationship, and a signal processor means to process the signal return and generate an image of targets in the area. The system can further include a sub-reflector means positioned in relation, to the radar system and the reflector.

### BRIEF DESCRIPTION OF THE DRAWINGS

The foregoing features of this invention, as well as tire invention itself, may be more fully understood from the following description of the drawings in which:

FIG. 1 is a schematic representation of an exemplary synthetic aperture radar system in accordance with exemplary embodiments of the invention;

FIG. 2 is a schematic representation of a further exemplary synthetic aperture radar system in accordance with exemplary embodiments of the invention;

FIG. 3 is a schematic representation showing illuminated areas;

FIG. 4 is a functional block diagram of an exemplary synthetic radar system;

FIG. 4A is a pictorial representation of an exemplary GaN MMIC to implement a portion of the system of FIG. 4;

FIG. 5 is a schematic representation of an exemplary synthetic aperture radar system, having a sub-reflector;

FIG. 5A is a schematic representation of an exemplary synthetic aperture radar system having a ring-shaped reflector;

FIG. 6 is a schematic representation of an exemplary synthetic aperture radar system having a further sensor to remove target ambiguities;

FIG. 7 is a flow diagram showing exemplary steps for processing data; and

FIG. 8 is a schematic representation of an exemplary computer that can performing at least a portion of the processing described herein.

### DETAILED DESCRIPTION

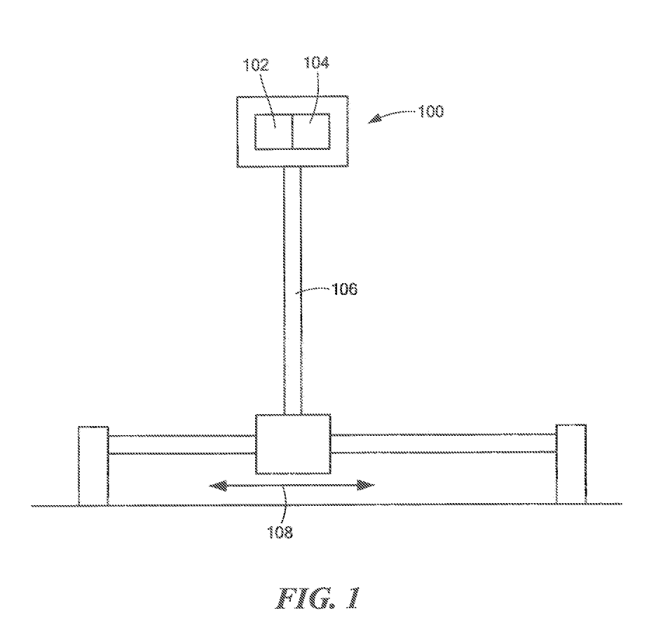

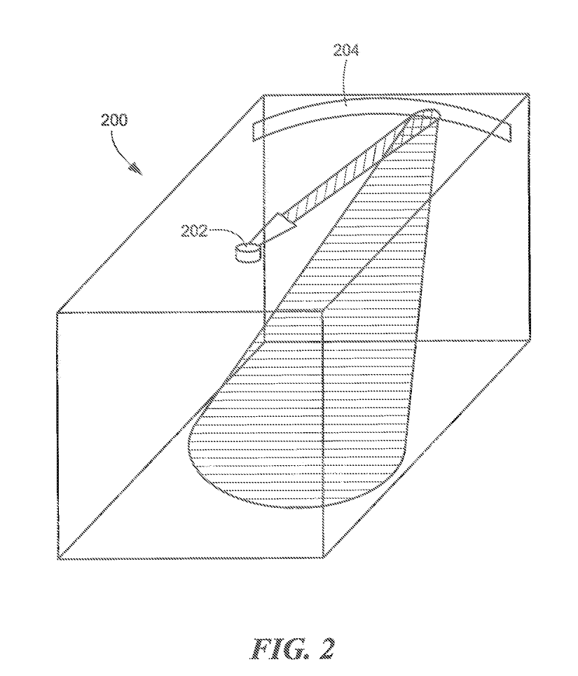

FIG. 1 shows an exemplary system 100 having transmit and receive horns 102, 104 mounted on top of a linear positioner 106. The transmit and receive horns point 102, 104 can point down to illuminate an area. The linear positioner 106 is moved along a line perpendicular to the target direction, as indicated by arrow 108. In one embodiment, radar data, across the band is taken in about one wavelength increments along the translation path. The collected date can he processed using synthetic aperture radar (SAR) techniques.

Range resolution along a straight, line from the horns 102, 104 to the target better than one inch is obtained with a mmW bandwidth of >6 GHz, e.g., 12 GHz. Cross range resolution in the direction 108 of the transceiver translation of better than one inch is obtained with a transceiver translation length of approximately a meter (for ranges of less than 10 meters). Range and cross range data are combined to form a two dimensional image of the target.

It is understood that a range of frequencies can he used to meet the needs of a particular application. In one embodiment, bandwidth of 20% of a center frequency of the radar is used. In one particular embodiment, a center frequency of 90 GHz is used.

FIG. 2 shows an exemplary radar system 200 having an antenna 202 positioned in relation to a reflector 204. In one embodiment, the antenna 202 rotates so that the rotational radar beam movement in combination with the reflector provides translational radar beam movement that can be processed to obtain synthetic aperture radar (SAR) imagery. The rotating antenna 202 and the reflector 204 can obtain return signal data to provide a two-dimensional image of a scene from the relative movement of a single wideband radar transceiver/antenna and the imaged target.

In one embodiment, the reflector 204 that converts the beam to sweep linearly is typically in the order of several feet long and several inches in height. The actual dimensions are determined by the dimensions of the test area to be swept by the radar and the sizes of the objects to be imaged.

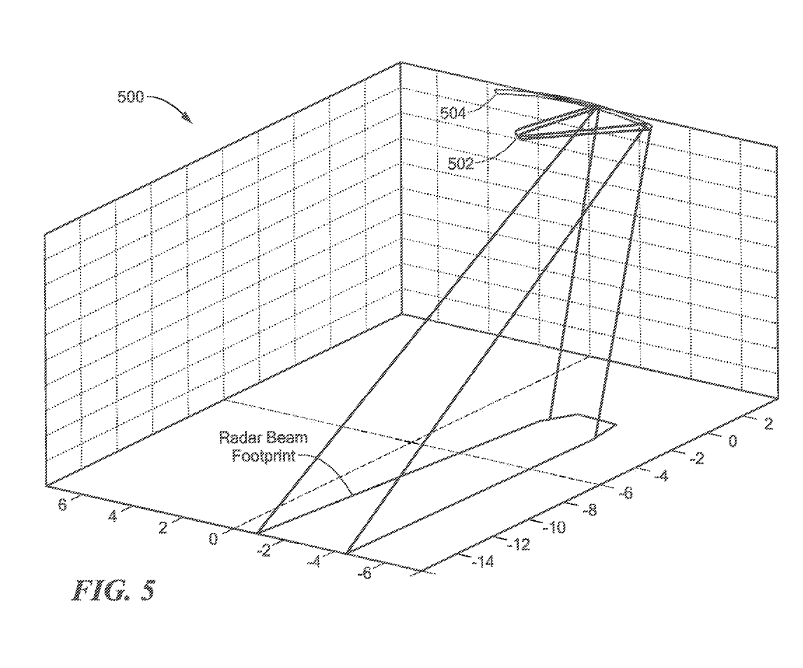

In an embodiment where the radar beans uses a ring shaped reflector (see FIG. 5A) to allow the radar beam to perform a 360 degree scan of an object, the reflector is in the order of several feet in diameter larger that the largest lateral dimension of the object to be scanned, and several inches high.

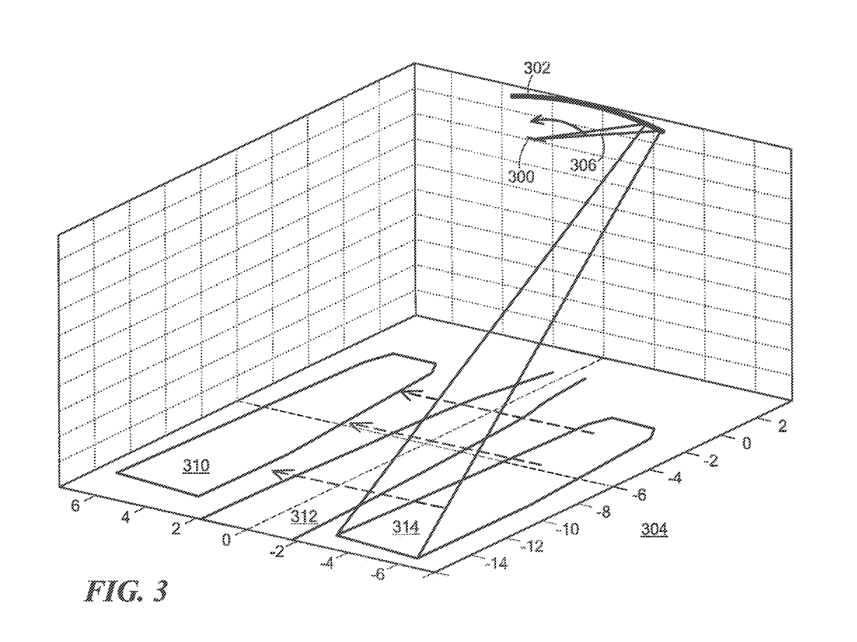

FIG. 3 shows a reflector antenna system converting a rotating radar transceiver into “Virtual” linear translation. A radar transceiver 300 illuminates a portion of a relatively wide and thin reflecting strip/reflector 302. Both the rotating radar transceiver 300 and the reflecting strip 302 are mounted above an area 304 to be scanned by the radar. The reflecting strip 302 reflects the transceiver antenna beam 306 down onto the area 304, Depending on the rotation angle of the transceiver 300. the beam 306 appears to emanate from a different location along the reflecting ship 302. This ‘virtual’ translation of the radar transceiver beam 306 can be then used for SAR processing.

In the illustrated embodiment, gradient antenna patterns are super-imposed on the ground. A first antenna pattern 310 corresponds to a transceiver rotation angle of −35 degrees, a second antenna pattern 312 corresponds to a transceiver rotation angle of zero degrees, and a third antenna pattern 314 corresponds to a transceiver rotation angle of +35 degrees. As can be seen, transceiver 300 rotation corresponds nicely to an antenna pattern linear translation for SAR processing. In the illustrated embodiment, the system images about a 10 m×10 m area. In exemplary embodiments of the invention, In order to obtain one inch or better range resolution, an RF bandwidth of >6 GHz is used.

In another embodiment, rotation of the radar beam can. also be accomplished by directing the stationary radar transceiver beam towards a rotating polygonal mirror, which “paints” the reflecting strip multiple times as it rotates. In order to generate a real-time dynamic image of a scene, the transceiver is only required to rotate at approximately ten revolutions per second, for example (or less if the polygonal mirror is used).

It is understood that larger and smaller areas can be imaged using larger and smaller main and sub reflectors to meet the needs of a particular application. It is further understood that additional reflectors can be used and shaped, e.g., curved and/or flat, to meet the needs of a particular application.

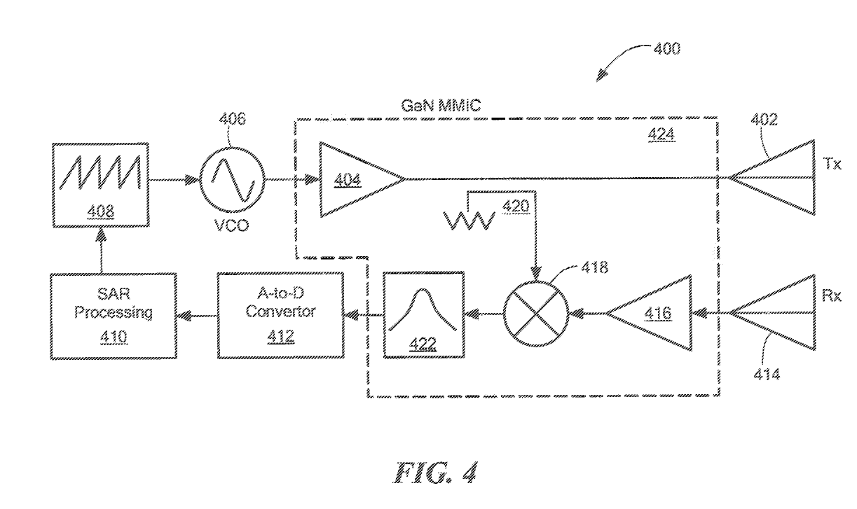

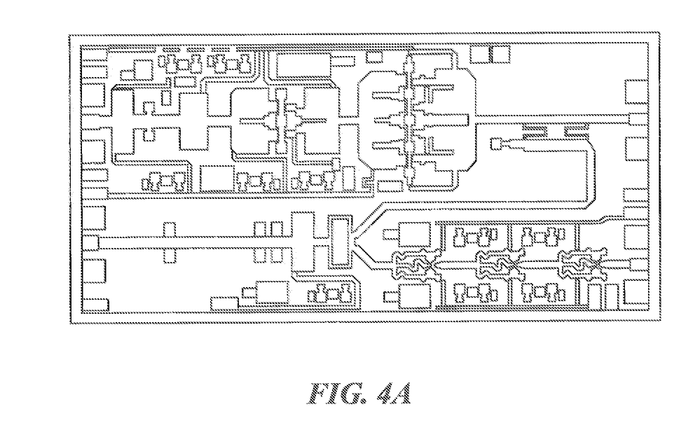

FIG. 4 shows an exemplary FMCW (Frequency Modulated Continuous Wave) front end 400 for an exemplary radar in accordance with exemplary embodiments of the invention. A transmit antenna 402 receives a transmit signal from a power amplifier 404 coupled to a voltage controlled oscillator (VCO) 406. A ramp generator 408 Is coupled between the VCO 406 and a SAR processing module 410, which receives information from an analog to digital converter (ADC) 412, which converts signal return information from a receive antenna 414.

Signals from the receive antenna 414 are provided to a low noise amplifier 416 having an output coupled to a mixer 418. The mixer 418 has an input from a directional coupler 420 connected to the output of the transmit power amplifier 404. The output of the mixer 418 is intermediate frequency filtered 422 and provided to the ADC 412.

As can be seen, the radiated RF signal is used as the LO (Local Oscillator) for the receive channel to automatically compress the wideband SAR data (6+ GHz) into about a 10 MHz wide IF band. This enables the use of the ADC 412 and SAR data processing hardware 410 to reduce system cost and complexity.

In one embodiment, some of the components can be provided in a GaN (Gallium Nitride) MMIC (Monolithic Millimeter wave Integrated Circuit) 424, FIG, 4A shows artwork for 3 mm×1.5 mm MMIC 424 shows in FIG 4.

In an exemplary embodiment shown in FIG. 5, a reflector antenna system 500 comprises a transceiver feed horn illuminating a sub-reflecting strip 502, which in-turn illuminates a main reflecting strip 504. In one embodiment, the sub-reflector 502 is about two feet wide and the main reflector 504 is about six meters wide. In an exemplary embodiment, the sub-reflecting strip 502 rotates with the transceiver.

FIG. 5A shows a further exemplary embodiment 550 for utilizing SAR imagery of objects while keeping the scanned volume of the radar to a minimum. A radar 552 resides in the center, for example, of a ring-shaped reflector 554. The reflector 554 directs the radar beam downward and back toward the radar axis of rotation 556. Objects placed beneath this radar/reflector configuration receive a 360 degree radar scan. In the illustrative, SAR imagery is produced that is similar to that obtained when an airborne SAR images objects while turning on a point centered on the object. This allows SAR imagery data to be rapidly collected on individual objects while keeping the volume of the equipment to a minimum.

It is understood that to achieve the desired SAR information, exemplary embodiments of the invention can achieve relative movement of the transceiver, reflector, and/or sub-reflector in any practical dimension. That is, one or more of the components can move in relation to the other.

In exemplary embodiments of the invention, the reflecting strip is not diffraction limited, hi one embodiment, the reflecting strip is constructed using metallic plated injection molded plastic for low cost fabrication. It is understood that a wide range of fabrication techniques known in the art can be used to form reflecting strips having characteristics to meet the needs of a particular application.

As is known, in the art, conventional diffraction-limited reflector antennas require RMS surface accuracies of 1/25^{th} of a wavelength to function properly (which is about 0.005″ for W-band)

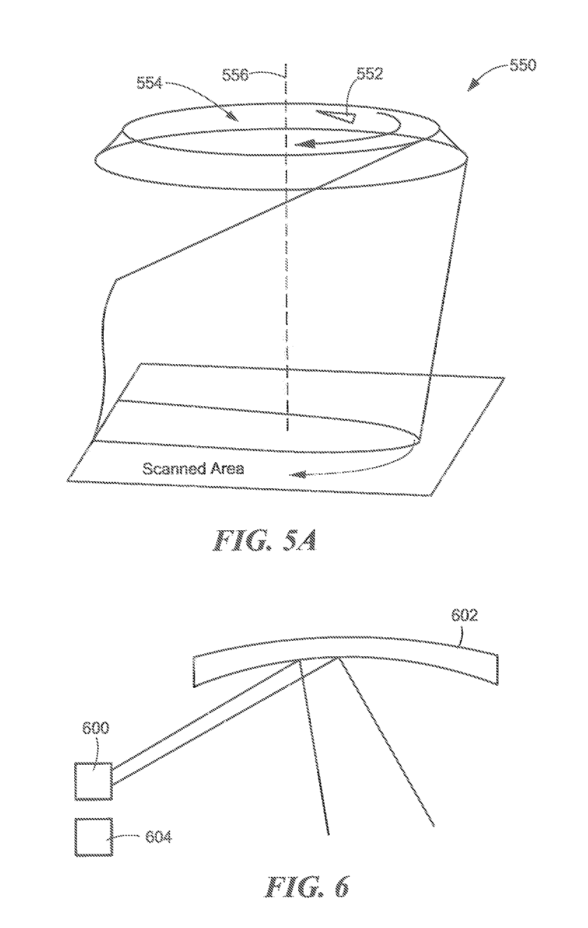

Since SAR data may only provide slant range and cross range information, it may be difficult to differentiate lengths along the ground from height differences. In exemplary embodiments of the invention, this limitation can be mitigated as shown in FIG. 6, by using a second sensor. A rotating transceiver 600 illuminates a reflector 602, as described above, and a second sensor 604 provides additional information.

In one embodiment, a radar scene is correlated with a scene from a visual camera provided as the second sensor 604. Image processing can he used to soil out ambiguities from the SAR processing. In an alternative embodiment, the second sensor 604 is provided as a second radar receiver slightly offset from the first radar 600 to enable interferometric SAR processing.

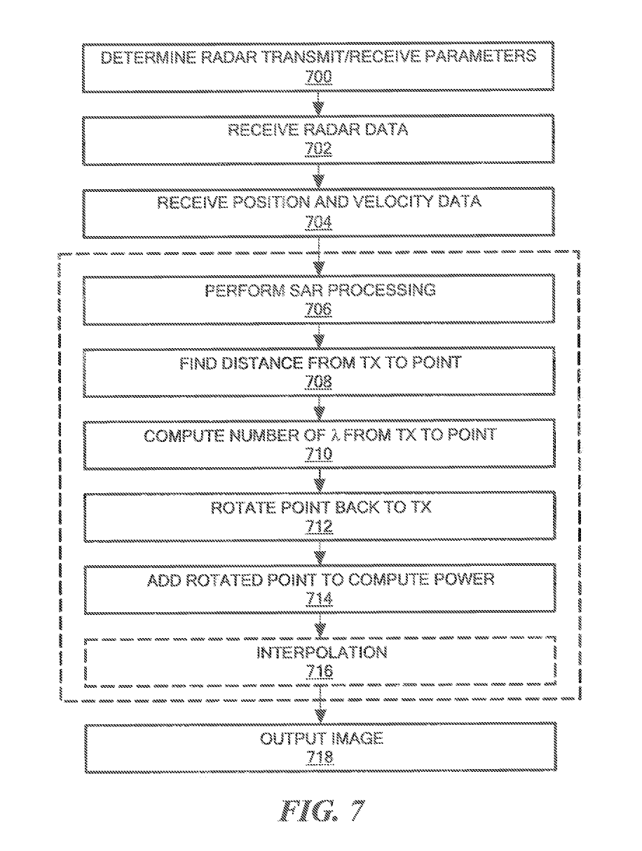

FIG. 7 shows an exemplary sequence of steps for processing data In a wide area synthetic aperture radar system in accordance with exemplary embodiments of the invention. It is understood, that processing raw SAR is essentially a geometry problem. In general, forming a synthetic aperture, such as by flying an aircraft with a radar, and processing the SAR data is well known in the art. An exemplary sequence of steps is set forth below for processing data collected using a synthetic aperture radar in accordance with the embodiments shown and described above.

In step 700, operating parameters for the radar are determined, such as frequency, and FMCW characteristics. Basic parameters include altitude, beamwidth, and look angle. In step 702, signal return is received by the -radar receiver and in step 704 position and velocity data is received. In step 706, SAR processing of the signal return is initiated.

In an exemplary embodiment, SAR processing includes finding a distance from the transmitter to any point in the scanned area in step 708, In step 710, the number of wavelengths from the transmitter to the points are computed. In step 712, points are rotated back to the transmitter using the fractional wavelength. In step 714, the rotated points are added to compute the power for a given point. In optional step 716, interpolation can be performed for a more sharply focused image. In step 718, the SAR image is output for visual inspection and/or further processing.

It is understood that any suitable SAR processing technique can. he used to meet the needs of a particular application. It is further understood that exemplary embodiments of the invention are applicable to a wide range of applications in which it. Is desirable to obtain images using radar. By providing a relatively high frame rate, compactness and fine resolution, exemplary embodiments of the invention are useful in traffic management, navigation, security applications, etc.

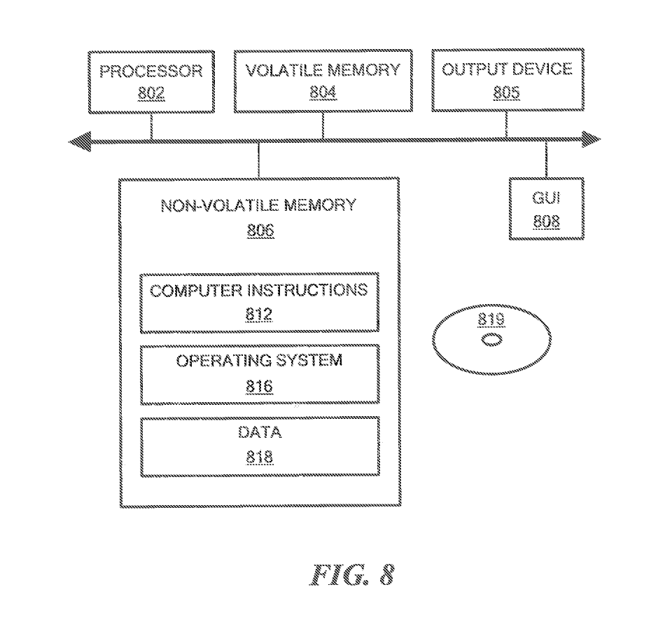

FIG. 8 shows an exemplary computer that can perform at least a part of the processing described herein. A computer includes a processor 802, a volatile memory 804, an output device 805, a non-volatile memory 806 (e.g., hard disk), and a graphical user interface (GUI) 808 (e.g., a mouse, a keyboard, a display, for example). The non-volatile memory 806 stores computer Instructions 812, an operating system 816 and data 818, for example. In one example, the computer instructions 812 are executed by the processor 802 out of volatile memory 804 to perform all or part of the processing described above. An article 819 can comprise a machine-readable medium that stores executable instructions causing a machine to perform any portion of the processing described herein.

Processing is not limited to use with the hardware and software described herein, and may find applicability in any computing or processing environment and with any type of machine or set of machines that is capable of running a computer program. Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Programs may be implemented in a high level procedural or object-oriented programming language to communicate with a computer system. However, the programs may be implemented in assembly or machine language. The language may be a compiled or an interpreted language and It may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that, is readable by a general or special purpose programmable computer for configuring and operating the computer when, the storage medium or device is read by the computer to perform processing.

Having described exemplary embodiments of the invention, It will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly Incorporated herein by reference in their entirety.

What is claimed is:

1. A system, comprising:
a first radar system having a transmitter to transmit signals to an area and a receiver to receive signal return from targets in the area;
a reflector positioned in relation to the first radar system to reflect transmit signals from the transmitter to the area and signal return from the targets to the receiver, wherein at least one of the transmitter and the reflector moves in relation to the other to provide a synthetic aperture radar relationship; and
a signal processor to process the signal return and generate an image of targets in the area.

2. The system according to claim 1, wherein the radar system comprises a rotating radar for converting a rotational radar beam movement into translational radar beam movement.

3. The system according to claim 2, wherein the reflector is stationary.

4. The system according to claim 1, wherein the reflector is parabolic.

5. The system according to claim 1, wherein the reflector is ring-shaped.

6. The system according to claim 1, further including a sub-reflector positioned in relation to the radar system and the reflector.

7. The system according to claim 1, wherein the radar system transmit signals have a frequency range of about 20 percent of a center frequency of the radar.

8. The system according to claim 1, wherein the reflector is not diffraction limited.

9. The system according to claim 1, further including a further sensor to mitigate ambiguities in the image.

10. The system according to claim 8, wherein the further sensor includes at least one of a video system and a second radar system offset from the first radar system.

11. A method, comprising;
employing a first radar system having a transmitter to transmit signals to an area and a receiver to receive signal return from targets in the area;
employing a reflector positioned In relation to the first radar system to reflect transmit signals from the transmitter to the area and signal return from the targets to the receiver, wherein at least one of the transmitter and the reflector moves in relation to the other to provide a synthetic aperture radar relationship; and
processing the signal return with a computer processor and generating an image of targets in the area.

12. The method according to claim 11, further including rotating a radar for converting a rotational radar beam movement into translational radar beam movement.

13. The method according to claim 11, wherein the reflector is ring-shaped.

14. The method according to claim 11, further including employing a sub-reflector positioned in relation to the radar system and the reflector.

15. The method according to claim 11, further including transmitting the transmit signals at a band width of up to 20 percent of a center frequency of the radar.

16. The method according to claim 11, wherein the reflector is not diffraction limited.

17. The method according to claim 11, farmer including employing a further sensor to mitigate ambiguities in the image.

18. The method according to claim 17, wherein the further sensor includes at least one of a video system and a second radar system, offset from the first radar system.

19. A system, comprising:
a first radar system having a transmitter to transmit signals to an area and a receiver to receive signal return from targets in the area;
a reflector means positioned in relation to the first radar system to reflect transmit signals from the transmitter to the area and signal return from the targets to the receiver, wherein at least one of the transmitter and the reflector moves in relation to the other to provide a synthetic aperture radar relationship; and
a signal processor means to process the signal return and generate an image of targets In the area.

20. The system according to claim 19, further including sub-reflector means positioned in relation to the radar system and tire reflector.
